(19) United States
(12) Patent Application Publication
(10) Pub. No.: US 2007/0030786 A1
(43) Pub. Date: Feb. 8, 2007

(54) Method of storing rll encoded information to an optical disc with control of the frequency of the information with respect to the cut-off frequency of the optical system

(76) Inventors: Theodorus Petrus Henricus Gerardus Jansen, Eindhoven (NL); Cornelis Marinus Schep, Eindhoven (NL); Aalbert Stek, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/557,640

(22) PCT Filed: May 13, 2004
(86) PCT No.: PCT/IB04/50688

§ 371 Date: Nov. 17, 2005

(30) Foreign Application Priority Data
May 21, 2003 (EP) 03076519.2
Jul. 24, 2003 (EP) 03102275.9

(51) Int. Cl. G11B 27/30

(52) U.S. Cl. 369/59.23

(57) ABSTRACT

A method of storing/retrieving information to/from an optical disc by means of an optical system with a cut-off frequency ν_{cut-off}, above which frequencies cannot be detected, is disclosed. The invention relates to Run Length Limited encoded information. According to the invention, some frequencies of the encoded information can be higher than cut-off frequency of the optical system, such that the equation 4*(d+1)*L_{cd}*NA/λₗₐₛₑᵣ<1 is satisfied, where d+1 is the minimum run length of the coding, L_{cd} is the length of a channel bit, NA is the numerical aperture and λₗₐₛₑᵣ is the wavelength of the optical system. Hereby, the capacity of the optical disc is increased, while the prevailing coding technique is used. Moreover, the invention relates to a disc for storing of data, a drive capable of storing data and an apparatus for manufacturing optical discs.

### FIELD OF THE INVENTION

This invention is related to a method of storing data to an optical disc and to a method of retrieving data from an optical disc. The invention moreover relates to a disc for storing of data, a drive capable of reading an optical disc, a drive capable of storing data to an optical disc and to an apparatus for manufacturing an optical disc.

### BACKGROUND OF THE INVENTION

Optical discs are electronic data storage mediums that hold information in digital form and that are written and read by a laser. These discs include all the various CD, DVD as well as Blu-ray Disc variations. Data are stored as fields of light and dark, so-called pits and lands for ROM or so-called marks and spaces for R or RW, which are read of a laser in an optical system and the data are converted into an electrical signal.

Most current optical recording systems use so-called bit modulation encoding to modulate the data to be stored so that it fit to the optical recording channel. The prevailing bit modulation encoding is run length limited encoding (RLL-coding).

Run length limited sequences are characterized by two parameters, d and k, which stipulate the minimum and maximum run length, respectively, that may occur in the sequence. The length of time, usually expressed in channel bits, between consecutive transitions is known as the run length. Run length constraints help to mitigate problems of inter-symbol interference and inaccurate clocking. The d-constraint helps to reduce inter-symbol interference, and the k-constraint helps to avoid inaccurate clocking.

Increasing the storage density on optical discs is a concern of great importance and attention. At present, it is known to try to reach higher storage densities by using more advanced signal processing, different modulation schemes (for instance multi-level techniques) or different physical principles (for instance super-resolution techniques), given the characteristics of the optical channel. Examples of the above include:

Magnetic super-resolution techniques such as MAMMOS (Magnetic Amplifying Magneto-Optical System) which use special magneto-optic materials to expand the bits during read-out. This option requires a different type of disc and a different type of read/write head compared to conventional optical recording systems. MAMMOS employs a double layer recording film which assures accurate playback of a much smaller magnetic moment The double layer consists of a bottom magnetic “recording” layer and a top “magnetic amplifying” layer. During playback, the small magnetic domain (recorded mark) of the recording layer is heated using a laser beam causing a new magnetic domain with the same magnetic orientation to form on the magnetic amplifying layer. By applying an external magnetic field in the same direction as the magnetic orientation, the magnetic domain of the amplifying layer grows, assuring accurate signal recognition during playback. A disadvantage of MAMMOS techniques is the need for recording stacks and accurate power control during read-out;

Optical super-resolution techniques such as super-RENS (Super-Resolution Near-Field Structure) which use non-linear optical effects in the read-out layer to make a smaller spot. This option also requires a different type of disc compared to conventional optical recording systems;

Multi-level recording which uses a different modulation scheme compared to RLL coding, viz. multi-level coding. The advantage of this method is that it uses conventional disc types, recording layers and read/write head. Disadvantages are an increased sensitivity for write power variations and cross-erase compared to conventional RLL coding. Cross-erase denotes the phenomenon that data written in a track undesirably may be erased by repeated writing in the adjacent track.

### OBJECT AND SUMMARY OF THE INVENTION

For the optical channel in conventional optical recording systems like Compact Disc (CD), Digital Versatile Disc (DVD) and Blu-ray Disc (BD), the highest spatial frequency (the cut-off frequency, ν_{cut-off}) that can be detected using the optical spot equals (approximately) 2*NA/λ, where λ is the wavelength of the laser and NA is the numerical aperture of the objective lens (See also: G. Bouwhuis et al., Principles of Optical Disc Systems, Adam Hilger Ltd., 1985). For Blu-ray Disc, for example, λ=405 nm and NA=0.85, so ν_{cut-off}=1/(238 nm).

The spatial frequency ν of the data on an optical disc to be transmitted by the optical channel should be smaller than the cut-off frequency to keep the resulting eye pattern open. An eye pattern is an oscilloscope display in which a pseudorandom digital data signal from a receiver is repetitively sampled and applied to the vertical input of the oscilloscope, while the data rate is used to trigger the horizontal sweep of the oscilloscope. An open eye pattern corresponds to minimal signal distortion. Distortion of the signal waveform due to e.g. inter-symbol interference and noise appears as closure of the eye pattern.

When using an RLL-code with a d-constraint for the coding of the data on the optical disc, the smallest effect has a length of (d+1)*L_{cb}, where L_{cb} is the length of a channel bit. A good estimation of the highest frequency νₘₐₓ in the RLL code is a carrier of the smallest effect: νₘₐₓ=1/(2*(d+1)*L_{cb}).

A channel bit is the smallest length unit used on an optical disc. On a BD with a capacity of 23.3 GB, the channel-bit length, L_{cb}, equals 80.0 nm; on a BD with a capacity of 25 GB, the channel-bit length, L_{cb}, equals 74.5 nm; and on a BD with a capacity of 27 GB, the channel-bit length, L_{cb}, equals 69.0 nm. On a DVD, which has a capacity of 4.7 GB, the channel-bit length, L_{cb}, equals 133.3 nm and on a CD, which has a capacity of 0.7 GB, the channel-bit length, L_{cb}, equals 277.7 nm.

On for example a Blu-ray Disc, an RLL-code is used with d=1 (so the smallest effect is 2 times the channel bit length long) and this implies that L_{cb} should be larger that 59.5 nm to keep the eye pattern open.

The consideration of an open eye pattern, i.e. all frequencies in the RLL-code are sufficiently transmitted by the optical channel, has been an important consideration in optical recording (see, for example, FIG. 7.10 in said “Principles of Optical Disc Systems”). This is also clear when we look at the parameters of existing optical disc systems: the ratio between the optical cut-off frequency ν_{cut-off} and the highest frequency νₘₐₓ in the RLL-code is always larger than 1 (See Table 1).

This ratio is given by the formula ν_{cut-off}/νₘₐₓ=2*(d+1)*L_{cb}*2*NA/λ.

TABLE 1

| | CD | DVD | BD | BD | BD |
|---|---|---|---|---|---|
| | (0.7 GB) | (4.7 GB) | (23.3 GB) | (25.0 GB) | (27.0 GB) |
| λ [nm] | 780 | 650 | 405 | 405 | 405 |
| NA | 0.45 | 0.60 | 0.85 | 0.85 | 0.85 |
| d | 2 | 2 | 1 | 1 | 1 |
| L_{cb} [nm] | 277.7 | 133.3 | 80.0 | 74.5 | 69.0 |
| ν_{cut-off}/νₘₐₓ | 1.92 | 1.48 | 1.34 | 1.25 | 1.16 |

As it can be seen from Table 1, the wavelength of the laser beam in an optical system used to read the DVD disc is shorter than that used for standard CDs and the wavelength used in BD is shorter than that used for DVD's. Also the NA of the objective lens in an optical system used to read the DVD disc is larger that that used for standard CDs and the NA used in BD is larger than that used for DVDs. Moreover, it can be seen that the ratio between ν_{cut-off} and νₘₐₓ is greater than 1 in all the cases of the prior art in Table 1, which, as stated above, signifies that the spatial frequency of the data on the optical disc in all cases is smaller that the cut-off frequency of the detecting system. This is in accordance with common logic: the spatial frequency of the data stored on the optical disc should be dimensioned so that it can be detected by the detection system. Moreover, the cut-off frequency of the optical detection system sets a limit for the capacity of the optical disc, as a function of the wavelength of the laser of the optical system and the numerical aperture of the optical system.

The RLL-coding is a “family” of bit modulation techniques, where two parameters define how RLL works, and therefore, there are several different variations. RLL-coding is a further development of Frequency Modulation (FM) encoding and Modified Frequency Modulation (MFM) encoding. In FM encoding there is a simple one-to-one correspondence between the bit to be encoded and the flux reversal pattern, so that only the value of the current bit is necessary. Modified Frequency Modulation (MFM) improves encoding efficiency over FM by more intelligently controlling where clock transitions are added into the data stream; this is enabled by considering not just the current bit but also the one before it This gives rise to a different flux reversal pattern for a 0 preceded by another 0, and for a 0 preceded by a 1. This “looking backwards” allows improved efficiency by considering more data in deciding when to add clock transitions. The term “clock transition” is meant to cover a means for clock synchronization added to the encoding sequence and used to determine the position on an optical disc of specific bits; the term “flux reversal” signifies the transition on the disc between a land and a pit Since some flux reversals are used to provide clock synchronization, these are not available for data and since each linear inch of space on a track on the optical disc can only store a limited amount of flux reversals, these are two of the limitations in recording density. The enhanced coding methods, such as RLL coding, is used to decrease the number of flux reversals used for clocking relative to the number used for real data, but still there is a need to enhance the storage capacity further.

Therefore, it is an object of the invention to provide a method to increase the capacity of an optical disc. It is especially an object to increase the storage capacity of an optical disc for a given wavelength of the laser of the optical system and a given numerical aperture of the optical system. It is a further object of the invention to increase the capacity of an optical disc, where data on the optical disc are encoded in RLL-encoding. The invention proposes a method of storing data to an optical disc and a method of retrieving data from an optical disc.

The method of storing data to an optical disc according to the invention, comprises the steps of encoding the data in a Run Length Limited (RLL) coding, where the RLL coding has a parameter d, wherein (d+1) is the minimum run length, which parameter d in combination with a length, L_{cb}, of a channel bit determine the maximum frequency, νₘₐₓ, of the RLL coding, storing the data by means of an optical system, which optical system has a numerical aperture NA and comprises a laser with a wavelength λₗₐₛₑᵣ used in the storing of the data, which wavelength λₗₐₛₑᵣ is associated with a cut-off frequency, ν_{cut-off}, of the optical system, and is characterized in that, the equation 4*(d+1)*L_{cb}*NA/λₗₐₛₑᵣ<1 is satisfied.

For a given optical system with a numerical aperture NA and a wavelength of the λₗₐₛₑᵣ Maser the cut-off frequency ν_{cut-off}, which is a limit frequency above which frequencies cannot be distinguished by the optical system, a good measure of ν_{cut-off} is given by the equation: ν_{cut-off}=2*NA/λₗₐₛₑᵣ. For a Run Length Limited Coding, a good estimation of the highest frequency νₘₐₓ is given by νₘₐₓ=1/(2*(d+1)*L_{cb}). Thus, the equation “4*(d+1)* L_{cb}*NA/λₗₐₛₑᵣ<1” corresponds to an indication of νₘₐₓ being greater than ν_{cut-off} for a given optical system and for a given RLL coding. When it is possible to detect frequencies above the cut-off frequency of the optical system, the spatial frequency of the data encoded in Bit Modulation coding can be increased above what is known in the prior art, and thereby the capacity of the optical disc is increased

According to a preferred embodiment d satisfies the equation: d≧1. When d≧1 the cases of CD, DVD and BD are covered, so that the method to store data to an optical disc can be used to the discs currently used.

In a preferred embodiment of the invention λₗₐₛₑᵣ=405 nm+/−40 nm. These wavelengths correspond to optical systems to write to/read from Blu-ray Discs or Blue DVDs. The numerical aperture of such systems could preferably be NA=0.85 or 0.65. In yet a preferred embodiment, λₗₐₛₑᵣ=650 nm+/−65 nm. These wavelengths correspond to optical systems to write to/read from DVD-discs. The numerical aperture of such systems could preferably be NA=0.60 or NA=0.65.

In yet a further embodiment, the RLL coding is asymmetric. This means that the d-constraint is different for marks (d1) and spaces (d2) in the RLL coding on the optical disc. In this case the parameter d is interpreted as d=(d1+d2)/2, which gives the maximum frequency by the equation: νₘₐₓ=1/((d1+1+d2+1)*L_{cb}), and in the preferred embodiment the relation 2*(d1+d2+2)*L_{cb}*NA/λₗₐₛₑᵣ<1 is satisfied.

The invention moreover relates to a method of retrieving data from an optical disc, where the data on the optical disc is encoded in a Run Length Limited (RLL) coding, where the RLL coding has a parameter d, wherein (d+1) is the minimum run length, which parameter d in combination with a length, L_{cb}, of a channel bit determine the maximum frequency, νₘₐₓ, of the RLL coding, which method comprises the steps of reading the data by means of an optical system, which optical system has a numerical aperture NA and comprises a laser with a wavelength λₗₐₛₑᵣ used in the storing of the data, which wavelength λₗₐₛₑᵣ is associated with a cut-off frequency, λ_{cut-off}, of the optical system, decoding the data, and which method is characterized in that, the equation 4*(d+1)*L_{cb}*NA/λₗₐₛₑᵣ<1 is satisfied. This offers the same advantages as mentioned above in connection with the method of storing data to an optical disc.

Moreover, preferred embodiments of the method of retrieving data from an optical disc gives advantages corresponding to those obtained by the preferred embodiments of the method of storing data to an optical disc.

Finally, the invention provides a disc for storing of data according to the method of storing data to or retrieving data from an optical disc; a drive capable of reading a disc with data stored according to the method of storing data to an optical disc; a drive capable of storing data to an optical disc according to the method of storing data to an optical disc as well as an apparatus for manufacturing an optical disc.

### DESCRIPTION OF PREFERRED EMBODIMENTS

An optical system used to store data to or retrieve data from an optical disc has a cut-off frequency, λ_{cut-off}, above which frequencies cannot be distinguished by the optical system. Typically this cut-off frequency is determined by the numerical aperture NA of the optical system and the wavelength of the optical means, typically a laser, used in the optical system.

The invention is based on the basic idea that, in an optical system to store and/or retrieve data to and/or from an optical disc, it is possible that the maximal spatial frequency, νₘₐₓ, of the coding of the data is larger than the cut-off frequency, ν_{cut-off}, of the optical system.

One preferred embodiment of the present invention uses RLL-coding with a parameter d, where (d+1) is the minimum run length. The length, L_{cb}, of a channel bit determines together with the parameter d a maximum frequency, νₘₐₓ, of the RLL coding of the data. As mentioned, the present invention uses RLL-coding with the special condition that ν_{cut-off}>νₘₐₓ, i.e. that ν_{cut-off}/νₘₐₓ<1. This is expressed by the equation: 4*(d+1)*L_{cb}*NA/λₗₐₛₑᵣ<1. This can be implemented in the methods of the invention when a carrier of the shortest run lengths (with spatial frequency νₘₐₓ) is not transmitted. When reading such a carrier of the shortest run lengths, instead of being transmitted the carrier will be averaged out by the optical channel and the output of the channel will be zero. To be able to distinguish between a carrier of the shortest run length and a carrier of the shortest but one run length, the latter should be transmitted through the optical channel. This sets a lower limit on the ratio ν_{cut-off}/νₘₐₓ. If an RLL coding is used with a constraint “d”, meaning that the shortest run length has the length “d+1”, a carrier of run length “d+2” should have a frequency of at most ν_{cut-off}.

The frequency of a carrier of run length “d+2” equals 1/(2*(d+2)*L_{cb}), so the smallest ratio of ν_{cut-off}/νₘₐₓ that can be achieved with a RLL code is (d+1)/(d+2). For d=0, this ratio equals ½; for d=1, this ratio equals ⅔.

So when retrieving the data from the optical disc, the carrier of the shortest run length is averaged out by the optical channel, so that the output of the optical channel will be zero, but the carrier of the shortest but one run length is not averaged out, the zero output of the optical channel only occurs for the shortest run lengths. When the output of the channel is zero for some time (multiple channel bits in a row), a carrier of the shortest run lengths can thus be filled in. In this way the carrier can be detected, although it is not transmitted through the channel.

A part of the decoding of the data on the disc is detection of the lands and pits on the disc. For the detection, a so-called Maximum Likelihood Sequence Detector (MLSD) can be used. Such a detector is not hampered by the missing frequencies. It uses a model of the optical channel, looks at the waveform read from the disc and determines the most likely pattern on the disc to correspond to this waveform. A practical implementation of an MLSD is a so-called Viterbi detector (for instance described in chapter 7 of the book “Digital Baseband Transmission and Recording”, Jan W. M. Bergmans, Kluer Academic Publishers, Dordrecht, the Netherlands, 1996).

The above applies to any kind of optical disc whereon RLL coding is used. Examples of such disc are Compact Discs (CD), Digital Versatile Discs (DVD) and Blu-ray Discs (BD).

In a preferred embodiment of the invention, d≧1. For d=1, ν_{cut-off}/νₘₐₓ=(d+1)/(d+2)=⅔. The value of the constraint d=1 is a value commonly used in the RLL coding on Blu-ray Discs. For d=2, ν_{cut-off}/νₘₐₓ=(d+1)/(d+2)=¾. The value of the constraint d=2 is a value commonly used in the RLL coding on Compact Discs and Digital Versatile Discs. However, the value of d=0 is also conceivable, as mentioned above.

In a preferred embodiment an optical system with a 405 nm blue-violet semiconductor laser, a 0.85 NA field lens and a 0.1 mm optical transmittance protection disc layer structure is used. This corresponds to Blu-ray Discs. If d=1, this corresponds to BD coding as well. The invention facilitates the enhancement of the disc capacity beyond the 27 GB per layer of data known from the Blu-ray Discs. It is also conceivable, that NA=0.65, when λₗₐₛₑᵣ=405 nm.

The basic structure of all CDs and DVDs comprises a polycarbonate substrate, a thin, reflective metal layer, and a protective outer layer. In a preferred embodiment an optical system with a 650 nm red laser, a 0.60 NA or 0.65 NA field lens and a 0.6 mm substrate is used. This corresponds to DVD technology. d=2 corresponds to common DVD coding as well. The invention thus facilitates the enhancement of the disc capacity beyond the about 4.7 GB per layer known from the DVDs today.

The methods of the invention can also be applied to CDs. In this instance λₗₐₛₑᵣ=780 nm, NA=0.45 and d=2. Thus the invention can be used to increase the storage capacity of common CDs beyond the 0.7 GB known today.

In a preferred embodiment the RLL coding could include asymmetric RLL codes, i.e. that the d-constraint differs for pits and lands. Asymmetric RLL encoding comprises encoding data bits using an RLL encoding constraint in the form of M/N (d, k), where M is the number of input data bits, N is the number of output bits associated therewith, d is the minimum number of 0's between adjacent data bit 1's in the output data string, and k is the maximum number of 0's between adjacent data bit 1's. The values of d and k are adjusted during the encoding process based upon the even or oddness of the data bit 1 detected. That is, every other 1 data bit alters the encoding constraints and establishes a different (dx, ky) type constraint for the separation between adjacent ones by alternating between two values of d and k. This means that first the code assumes a value (d1, k1) and then a value (d2, k2). Then the remaining input data string is encoded by alternating between the (d1, k1) and (d2, k2) constraints. The encoding constraints can utilize either k1=k2 or k1≠k2 as well as fractional values for d1, d2, k1, and k2. In this manner, the amount of space allocated for 0's recorded between 1's is changed so that within a land the coding has one coding value and between adjacent land the minimum 0 count of the coding value is lower. Thereby, a new constraint allows the non-land regions to consume less area than the land regions and thus the linear recording density for and thereby the capacity of optically stored data is increased compared to traditional RLL encoding. The present invention thus increases this already increased capacity further.

In the above, no distinction between storage of data on an optical disc and retrieval of data from an optical disc has been made, since the description is meant to cover both storage and retrieval of data to/from optical discs.

1. A method of storing data to an optical disc, comprising the steps of
encoding the data in a Run Length Limited (RLL) coding, where the RLL coding has a parameter d, wherein (d+1) is the minimum run length, which parameter d in combination with a length, L_{cb}, of a channel bit determine the maximum frequency, νₘₐₓ, of the RLL coding,
storing the data by means of an optical system, which optical system has a numerical aperture NA and comprises a laser with a wavelength λₗₐₛₑᵣ used in the storing of the data, which wavelength λₗₐₛₑᵣ is associated with a cut-off frequency, ν_{cut-off}, of the optical system, characterized in that, the equation 4*(d+1)*L_{cb}*NA/λₗₐₛₑᵣ<1 is satisfied.

2. A method according to claim 1, characterized in that d≧1.

3. A method according to claim 1, wherein λₗₐₛₑᵣ=405 nm+/−40 nm.

4. A method according to claim 1, wherein λₗₐₛₑᵣ=650 nm+/−65 nm.

5. A method according to claim 1, characterized in that the RLL coding is asymmetric with two parameters, d1 and d2, and where the parameter d is interpreted as d=(d1+d2)/2, so that the equation 2*(d1+d2+2)*L_{cb}*NA/λₗₐₛₑᵣ<1 is satisfied.

6. A method of retrieving data from an optical disc, where the data on the optical disc is encoded in a Run Length Limited (RLL) coding, where the RLL coding has a parameter d, wherein (d+1) is the minimum run length, which parameter d in combination with a length, L_{cb}, of a channel bit determine the maximum frequency, νₘₐₓ, of the RLL coding, the method comprising the following steps:
reading the data by means of an optical system, which optical system has a numerical aperture NA and comprises a laser with a wavelength λₗₐₛₑᵣ used in the storing of the data, which wavelength λₗₐₛₑᵣ is associated with a cut-off frequency, ν_{cut-off}, of the optical system,
decoding the data,
characterized in that, the equation 4*(d+1)*L_{cb}*NA/λₗₐₛₑᵣ<1 is satisfied.

7. A method according to claim 6, characterized in that d≧1.

8. A method according to claim 6, wherein λₗₐₛₑᵣ=405 nm+/−40 nm.

9. A method according to claim 6, wherein λₗₐₛₑᵣ=650 nm+/−65 nm.

10. A method according to claim 6, characterized in that RLL coding is asymmetric with two parameters, d1 and d2, and where the parameter d is interpreted as d=(d1+d2)/2, so that the equation 2*(d1+d2+2)*L_{cb}*NA/λₗₐₛₑᵣ<1 is satisfied.

11. A disc for storing of data according to the method according to claim 1.

12. A drive capable of storing data to an optical disc according to claim 1.

13. A drive capable of retrieving data from an optical disc according to the method of claim 6.

14. An apparatus for manufacturing an optical disc according to claim 1.
